(19) United States
(12) Patent Application Publication
(10) Pub. No.: US 2026/0117805 A1
(43) Pub. Date: Apr. 30, 2026

(54) Bolt Retainer System

(71) Applicant: Loren Brian Nelson, Ralls, TX (US)

(72) Inventor: Loren Brian Nelson, Ralls, TX (US)

(21) Appl. No.: 19/375,159

(22) Filed: Oct. 30, 2025

Related U.S. Application Data
(60) Provisional application No. 63/714,133, filed on Oct. 31, 2024.

(51) Int. Cl. F16B 5/02; E01F 9/631

(52) U.S. Cl. CPC F16B 5/02; E01F 9/644

(57) ABSTRACT

A multi-piece bolt retainer system for use with a triangular slip base system for breakaway road sign installation is disclosed. The assembly includes a plurality of independent bolt retainer members each configured to engage and retain a respective bolt positioned between a top and bottom slip base plate. The modular configuration facilitates precise installation, uniform torque distribution, and predictable slip performance during vehicle impact.

### CROSS-REFERENCE TO RELATED APPLICATIONS

This application is related to and claims priority from earlier filed U.S. Provisional Patent Application No. 63/714,133, filed Oct. 31, 2024, the disclosure of which is incorporated herein by reference.

### BACKGROUND OF THE INVENTION

### 1. Field of the Invention

The present invention generally relates to attachment of sign support posts to ground stubs for installing breakaway roadside signs, and more specifically relates to a multi-piece bolt retainer system for use with a triangular slip base system.

### 2. Description of Related Art

Traffic signs communicate rules, warnings, guidance, and other highway agency information that drivers need to safely and efficiently navigate roads and streets. Sign support posts are vertical posts used to display traffic signs. Many support posts for roadside signs are configured as round tube steel posts. These posts are often anchored with breakaway bases in order to comply with regulatory safety standards.

Due to the location of signs and sign support posts on the roadside, sign support posts can become a deadly hazard when struck by a vehicle. If not properly designed, these posts can cause severe vehicle damage, occupant injury, or even fatalities. Therefore, the Federal Highways Administration (“FHWA”) requires roadside sign support posts to be breakaway, yielding, or shielded by a barrier or crash cushion. Breakaway support posts are designed to break or bend upon impact to reduce the severity of vehicle crashes. This includes sign support posts that, when struck by a vehicle, separate from the base and are knocked ahead of, or up and over, the vehicle.

Current triangular slip base systems are safety breakaway support structures widely used for roadside signposts on highways, streets, and other traffic control installations. These systems are designed so that when a vehicle collides with a signpost from any direction, the base allows the post to “slip” or break away cleanly, minimizing damage to the vehicle and reducing the risk of injury to occupants, while also making the sign easy to reinstall. Design problems with current breakaway sign support systems, however, present disadvantages that are overcome by the present invention.

Current triangular slip base systems comprise a top slip base plate and bottom slip base plate disposed in mirrored alignment to one another. In current systems, the top plate and the bottom plate are held together by bolts designed to release under a predetermined shear or bending load. To facilitate installation and retention of these bolts, a one-piece bolt keeper is used to hold the bolts in position relative to the slip base plates.

Conventional bolt keepers used in triangular slip base assemblies are constructed as a one-piece keeper that maintains all bolts in a fixed geometric relationship. Although such designs can simplify initial handling and preassembly, they present several limitations and disadvantages in practical use. One-piece bolt keepers can make installation and alignment more difficult. Because the bolts are rigidly fixed in a common body, the entire assembly must be positioned with a high degree of precision relative to the corresponding bolt-receiving holes in the triangular slip plates. Field conditions, such as uneven surfaces or minor variations in hole spacing between base plates made by different manufacturers, can lead to cross-threading, misalignment, or uneven bolt engagement.

It is common for bolts, retained by current one-piece bolt keepers, to dislodge from slip-base notches during normal use conditions, including light wind and vibrations. Loosening or rotation of the bolts caused by wind or vibration can result in unwanted movement of the post and sign, potentially leading to rotation or detachment of the signpost from the slip base system.

Current one-piece bolt keepers complicate maintenance and replacement. Upon vehicle impact with a roadside sign supported by a triangular slip base system, the resulting forces cause one or more corners of a current bolt keeper to fracture or tear as the bolts are driven out of their respective apertures in the bolt keeper. Additionally, if one bolt or nut becomes damaged, corroded, or seized, the entire keeper assembly may need to be removed or replaced. This increases the cost and time required for field servicing.

Moreover, rigid one-piece bolt retainers may negatively affect breakaway performance. During vehicle impact, the bolt keeper can bind or distort, causing uneven release of bolts or incomplete separation of the slip base plates. Such uneven breakaway behavior can compromise the energy absorption characteristics of the system and increase the risk of improper failure modes that do not meet regulatory breakaway criteria. Additionally, prior art assemblies typically require bolt torques of about eighty-five foot-pounds, whereas when using the disclosed bolt retainer system, the slip base assembly achieves proper clamping and breakaway performance with a bolt torque of approximately forty foot-pounds. The lower bolt torque requirement of the disclosed assembly results in improved breakaway performance relative to prior art designs that require significantly higher installation torque.

Finally, one-piece bolt keepers typically require precise manufacturing tolerances and uniform base geometry to function correctly. Small dimensional variations among different slip base components can prevent proper fit or lead to overstressing of the keeper or bolts. Rigid metallic keepers may crack or deform under torque or impact, while softer materials may fail to retain the bolts adequately over time.

In view of the foregoing, it is apparent that a need exists in the art for a bolt retainer system that overcomes, mitigates or solves the above problems in the art. It is a purpose of this invention to fulfill this and other needs in the art which will become more apparent to the skilled artisan once given the following disclosure.

### OBJECTS AND SUMMARY OF THE INVENTION

It is an object of the present invention to overcome the above-described drawbacks associated with current one-piece bolt keepers and triangular slip base systems. To achieve these and other advantages and in accordance with the purpose of the invention, as embodied and broadly described, the present disclosure describes a multi-piece bolt retainer system for retaining bolts in triangular slip base systems.

The disclosed bolt retainer system provides an improved bolt retention system for use with breakaway signposts utilizing a triangular slip base system. The disclosed bolt retainer system includes a plurality of independent bolt retainer members, preferably three, each configured to engage and retain a corresponding bolt disposed between a top and bottom slip base plate. The independent retainer members are individually positionable to accommodate field tolerances and variations in plate geometry. This arrangement allows each bolt to be properly aligned and torqued without imposing rigid geometric constraints typical of one-piece bolt keepers.

Each bolt retainer member includes a body portion having a tail configured to maintain the bolt retainer and corresponding bolt in position between a top and bottom slip base plate. Additionally, each bolt retainer member comprises a bolt-receiving aperture for receiving a bolt therethrough. Each bolt retainer member may further comprise an orientation tab or the like to insure proper alignment of the tail between the top and bottom slip base plates.

By permitting independent bolt positioning and uniform clamping, the disclosed multi-piece bolt retainer system promotes predictable separation of the slip base components upon impact, ensuring compliance with breakaway performance criteria. The multi-piece configuration also facilitates replacement of individual bolts or retainers without replacement of the entire base assembly. The multi-piece configuration facilitates precise installation, uniform torque distribution, and predictable slip performance during vehicle impact.

The disclosed invention provides a multi-piece bolt retainer system comprising three individual bolt retainer members arranged to correspond to the vertices of a triangular slip base pattern. Unlike conventional one-piece bolt keepers that rigidly interconnect all slip base fasteners in a fixed geometry, the disclosed system employs a multi-piece, and preferably three-piece, bolt retainer assembly. Each bolt retainer member is configured to correspond to a respective bolt location of the triangular pattern, thereby permitting independent positioning and alignment of each bolt while maintaining proper geometric orientation relative to the base plates. The segmented configuration allows the installer to accommodate variations in hole spacing, plate flatness, and field tolerances, simplifying assembly and improving uniform torque distribution. In the event of impact, the independent bolt retainers provide predictable separation of the slip base components. The multi-piece design further facilitates replacement of individual retainers or bolts, if required, without requiring replacement of the entire assembly, thereby reducing costs and maintenance time.

The disclosed slip base assembly achieves proper clamping and breakaway performance with a bolt torque of approximately forty foot-pounds, as compared to prior art assemblies that require bolt torques of approximately eighty-five foot-pounds. As a result, the disclosed invention lowers the energy required to activate the breakaway feature of an attached signpost under impact conditions, which makes attached signposts much safer for the traveling public.

These, together with other objects of the invention, along with various features of novelty that characterize the invention, are pointed out with particularity in the claims annexed hereto and forming a part of this disclosure. For a better understanding of the invention, its operating advantages, and the specific objects attained by its uses, reference should be had to the accompanying drawings and descriptive matter in which illustrative embodiments of the invention are described.

### BRIEF DESCRIPTION OF THE DRAWINGS

The accompanying drawings, which are incorporated in and form a part of the specification, illustrate embodiments of the present invention, and together with the description, serve to explain the principles of the invention. It is to be expressly understood that the drawings are for the purpose of illustration and description only and are not intended as a definition of the limits of the invention. In the drawings:

FIG. 1 is a side perspective view of a prior art triangular slip base system utilizing a bolt retainer system constructed in accordance with the teachings of the present disclosure.

FIG. 2 is a top view of the system shown in FIG. 1.

FIG. 3 is a top view of a bottom base plate of a prior art triangular slip base system.

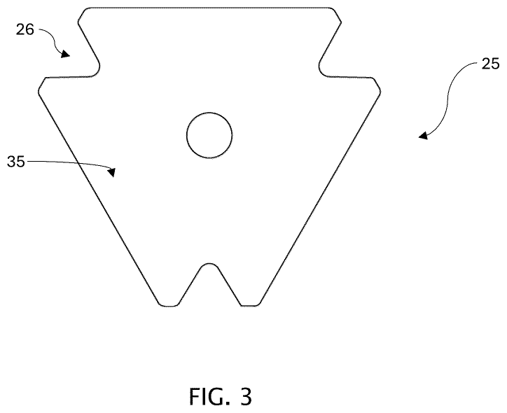

FIG. 4 is a perspective view of a bolt retainer member constructed in accordance with the teachings of the present disclosure.

FIG. 5 is a front view of the bolt retainer member shown in FIG. 4.

### DETAILED DESCRIPTION OF ILLUSTRATIVE EMBODIMENTS

Exemplary embodiments of a multi-piece bolt retainer system comprising three individual bolt retainer members in accordance with the present disclosure are discussed herein. Many other uses of the present invention will become obvious to one skilled in the art upon acquiring a thorough understanding of the present invention. Once given the below disclosures, many other features, modifications and variations will become apparent to the skilled artisan in view of the teachings set forth herein. Such other features, modifications and variations are, therefore, considered to be a part of this invention.

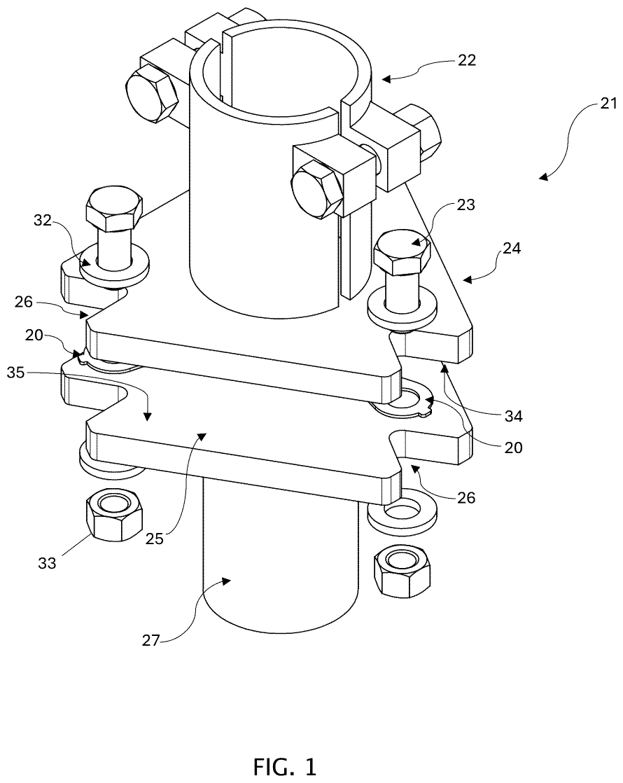

In FIG. 1, a prior art triangular slip base system 21 is illustrated comprising a top slip base plate 24 and a bottom slip base plate 25 disposed in mirrored alignment to one another. The bottom surface 34 of the top slip base plate 24 aligns with the top surface 35 of the bottom slip base plate 25. Each plate further comprises three bolt-receiving notches 26 disposed at the three vertices of the top base plate 24 and at the three vertices of bottom base plate 25. A plurality of base plate attachment bolts 23 extend through aligned bolt-receiving notches 26 in the top and bottom plates 24 and 25. The bolts 23 may be installed from beneath the bottom plate 25 with their threaded shanks extending upwardly to engage the corresponding bolt-receiving notches 26 of the overlying top base plate 24. Nuts 33 may be used to clamp the top base plate 24 to the underlying bottom base plate 25. Washers 32 may be installed between the heads of the bolts 42 and the base plate, and between the base plate and nuts 33.

In prior art systems, the three bolts are secured in position by a one-piece triangular-shaped bolt keeper (not depicted) disposed between the bottom surface 34 of the top base plate 24 and the top surface 35 of the bottom base plate 25. The prior art bolt keeper includes an aperture at each vertex of its triangular body for receiving a corresponding bolt. This single-piece bolt keeper functions to hold the slip base assembly together by maintaining the bolts, nuts, and washers in a coupled arrangement. Upon vehicle impact with a roadside sign supported by such a prior art slip base system, the resulting forces cause one or more corners of the prior art one-piece bolt keeper to fracture or tear as the bolts are driven out of their respective apertures. Once the bolts tear away from the keeper and disengage from the bolt-receiving notches, the top base plate separates from the bottom base plate, permitting the sign post to release from the slip base system.

A multi-piece bolt retainer system for use in connection with current triangular slip base systems 21 has not been previously anticipated or taught. Turning back to FIG. 1, a prior art triangular slip base system 21 utilizing the disclosed multi-piece bolt retainer system (20a, 20b, and 20c) is illustrated. The disclosed multi-piece bolt retainer system (20a, 20b, and 20c) is intended to replace prior art one-piece bolt keepers.

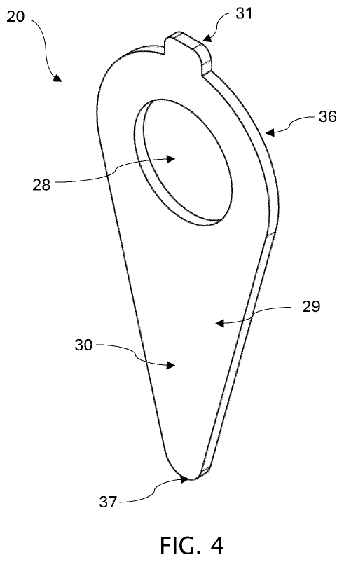

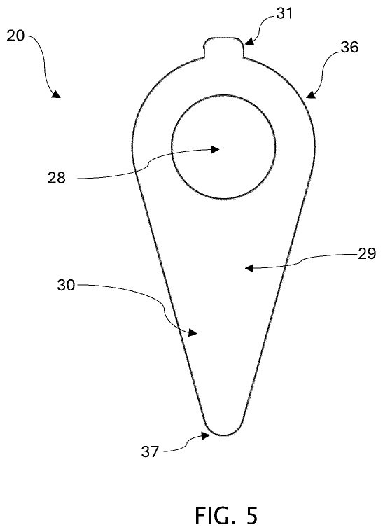

As shown in FIGS. 4-5, the bolt retainer members 20 comprise a body 29 comprising a tail member 30 and a head member 36 opposite said tail member 30, a bolt-receiving aperture 28, and a tail orientation tab 31 disposed on said head member 36. The tail member 30 is arranged and configured to be clamped in a fixed position between the top base plate 24 and the bottom base plate 25 by clamping force and friction. The tail member 30 of each bolt retainer member 20 extends from the bolt-receiving aperture 28 to a distal end 37 of the bolt retainer member 20.

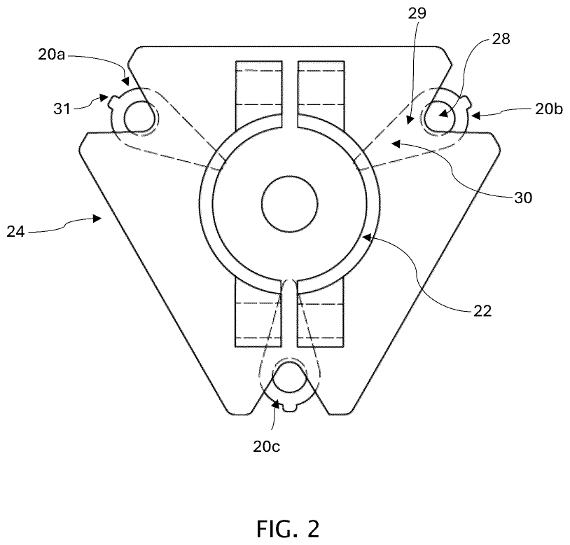

In FIG. 2, the three bolt retainer members 20 are arranged in a generally triangular configuration, with their head members 36 disposed at the vertices of a triangular pattern and with their distal ends 37 oriented inwardly toward a central region of the slip base assembly. This orientation allows the disclosed bolt retainer system to be configured as a multi-piece system having three separate bolt retainer members rather than as a one-piece retainer member. In this manner, the tail members 30 are retained in a fixed position between the top base plate 24 and the bottom base plate 25 during normal wind load and everyday use of an attached sign post.

The head member 36 of the bolt retainer member 20 surrounds a bolt-receiving aperture 28 and the head member may be configured as a rounded head as shown in the attached figures. In one embodiment, the body 29 of the bolt retainer member 20 is cone shaped with a rounded head 36 having a tail orientation tab 31 disposed at the top of said head 36. The head member 36, with a centrally disposed tail orientation tab 31, is arranged and configured to be exposed when installed in a slip base system 21. As shown in FIG. 2, the head member 36 is disposed between bolt-receiving notches 26 of the top base plate 24 and bottom base plate 25 when the bolt retainer system is installed.

A tail orientation tab 31 disposed on the head member 36 of each bolt retainer member 20 allows installers to ensure proper alignment of the retainer members 20 during installation and ensures that each bolt retainer member 20 and tail 30 is properly positioned relative to the center of the slip base system. The tail orientation tab 31 of each bolt retainer member is visible in the bolt-receiving notches 26 of the slip base system 21. When the tail orientation tab 31 is centrally aligned in the bolt-receiving notch 26, this informs the installer that the distal end 37 of the tail member 30 is properly aligned between the top base plate 24 and bottom base plate 25. A tail orientation tab may be disposed on the top of the head so that installers know which direction the tail is pointing. The tail orientation tab 31 may be configured in any manner that informs an installer of the orientation of the tail 30, which tail 30 is concealed between the top base plate 24 and bottom base plate 25 when the bolt retainer system is installed in a triangular slip base system 21.

As illustrated in FIG. 2, the bolt retainer system comprises three bolt retainer members 20a, 20b, and 20c. When installed, the tail members 30 of the bolt retainer members 20 are disposed between the top surface 35 of a bottom base plate 25 and the bottom surface 34 of a top base plate 24 of a prior art triangular slip base system. When installed, the head members 36 of the bolt retainer members 20 are exposed between the bolt-receiving notch 26 of a top base plate 24 and the bolt-receiving notch 26 of a bottom base plate 25.

In FIG. 1, a sign post mount for receiving and releasably retaining a signpost is mounted to the top base plate 24. A ground stub 27 mounted to the bottom base plate 25 is depicted. The ground stub may be used for anchoring the triangular slip base system 21 to a foundation.

As shown in FIG. 2, the bolt retainer system comprises three individual bolt retainer members 20a, 20b, and 20c, each configured to engage and retain a corresponding bolt positioned at one vertex of the triangular slip base system. Each bolt retainer member 20 includes a generally plate-like body 34 having a bolt-receiving aperture 28 for receiving a bolt shank. During installation, each bolt 23 is independently aligned and torqued, compensating for tolerances or uneven surfaces. Upon vehicle impact, the bolts shear or release uniformly as the plates 24 and 25 slip apart, ensuring predictable breakaway behavior. After impact, oftentimes the disclosed bolt retainers 20 can be reused, as the bolt retainers 20 are configured to be dislodged from the slip base system 21 rather than tearing, as occurs with current one-piece bolt keeper systems. Any damaged bolt or retainer member can be individually replaced without replacing the full assembly.

As will be understood by one skilled in the art, the above-described bolt retainer system may be made from metal or any other material known to those skilled in the art. Furthermore, as will be apparent to those skilled in the art, the shape of the bolt retainers can be changed to accomplish the objectives described herein. The geometry of the bolt retainers 20 is configured to provide an adequate contact surface area between the bolt retainers and the base plates for securely retaining the bolt retainers and bolts in the bolt-receiving notches. Furthermore, the geometry of the bolt retainers 20 is configured to require a decreased bolt torque of approximately forty foot-pounds to obtain proper clamping and breakaway performance, compared to the approximately eighty-five foot-pounds of bolt torque required for one-piece bolt keepers, resulting in effective and low-energy breakaway behavior during impact conditions.

It is important to note that the construction and arrangement of the elements of the invention provided herein are illustrative only. Although only a few exemplary embodiments of the present invention have been described in detail in this disclosure, those skilled in the art who review this disclosure will readily appreciate that many modifications are possible in these embodiments (such as variations in orientation of the components of the system, sizes, structures, shapes and proportions of the various components, etc.) without materially departing from the novel teachings and advantages of the invention.

Many other uses of the present invention will become obvious to one skilled in the art upon acquiring a thorough understanding of the present invention. Once given the above disclosures, many other features, modifications and variations will become apparent to the skilled artisan in view of the teachings set forth herein. Such other features, modifications and variations are, therefore, considered to be a part of this invention, the scope of which is to be determined by the following claims.

The invention claimed is:

1. A bolt retainer assembly installed in a triangular slip base system, the triangular slip base system including a top slip base plate having three bolt-receiving notches disposed at the three vertices of the triangular top base plate, a bottom slip base plate disposed in mirrored alignment to said top slip base plate, said bottom slip base plate having three bolt-receiving notches disposed at the three vertices of the triangular bottom base plate, said bolt retainer assembly comprising:
three bolt retainer members, each of said three bolt retainer members comprising:
a body comprising a tail member having a distal end, and a head member opposite said tail member; and
a bolt-receiving aperture formed between said head member and said tail member, wherein a base plate attachment bolt extends through one of said bolt-receiving notches in said top base plate, through said bolt-receiving aperture of said bolt retainer member, and through one of said bolt-receiving notches in said bottom base plate, such that said bolt-receiving aperture of said bolt retainer member is configured to engage and retain said bolt in said slip base system.

2. The bolt retainer assembly of claim 1, further comprising a tail orientation member disposed on said head member, said tail orientation member being configured to indicate the orientation of the tail member when said tail member is concealed between said top base plate and said bottom base plate and when said head member is disposed between said bolt-receiving notch of said top base plate and said bolt-receiving notch of said bottom base plate.

3. The bolt retainer assembly of claim 2, wherein said tail orientation tab disposed on the head member of each bolt retainer member indicates orientation of said tail member when said tail member is concealed between said top base plate and said bottom base plate.

4. The bolt retainer assembly of claim 2, wherein said tail orientation tab is centrally aligned between said bolt-receiving notch of said top base plate and said distal end of the tail member is oriented inwardly toward a central region of the slip base assembly.

5. The bolt retainer assembly of claim 1, wherein said head members of said bolt retainer members are each disposed at the vertices of said triangular top base plate and the vertices of said triangular bottom base plate with said distal ends oriented inwardly toward a central region of said slip base assembly.

6. The bolt retainer assembly of claim 5, wherein the tail members are concealed between the top base plate and the bottom base plate, and wherein the head members are disposed between said bolt-receiving notches of said top base plate and said bolt-receiving notches of said bottom base plate.

7. The bolt retainer assembly of claim 1, wherein the body of the bolt retainer member is cone shaped with a rounded head having a tail orientation member disposed at the top of said head.

8. The bolt retainer assembly of claim 7, wherein said tail orientation member is defined as a tail orientation tab.

9. The bolt retainer assembly of claim 8, wherein said tail orientation tab is centrally disposed on said head member.

10. The bolt retainer assembly of claim 1, wherein when installed, the tail members of the bolt retainer members are disposed between the top surface of a bottom base plate and the bottom surface of a top base plate of said triangular slip base system, and the head members are exposed between the bolt-receiving notch of a top base plate and the bolt-receiving notch of a bottom base plate.

11. A bolt retainer assembly for use with a triangular slip base system comprising a top slip base plate and a bottom slip base plate arranged in mirrored alignment, said bolt retainer assembly comprising:
three individual bolt retainer members, each configured to engage and retain a corresponding bolt positioned between the top base plate and the bottom base plates; and
each of said bolt retainer members being independently positionable relative to the other bolt retainer members;
wherein said bolt retainer members engage and retain said bolts in said slip base system.

12. The bolt retainer assembly of claim 11, wherein said bolt retainer members each comprise a head member, said head members being disposed at the vertices of a triangular pattern with said distal ends oriented inwardly toward a central region of said slip base assembly.

13. The bolt retainer system of claim 12, wherein said bolt retainer members each comprise a tail members connected to said head member, wherein when installed in said slip base system, said tail members are concealed between the top base plate and the bottom base plate, and wherein the head members are exposed between the top base plate and the bottom base plate.

14. The bolt retainer system of claim 13, further comprising a tail orientation member.

15. The bolt retainer system of claim 14, wherein said tail orientation member is disposed on the head member of each bolt retainer member, said tail orientation member indicating the orientation of said tail member when said tail member is concealed between said top base plate and said bottom base plate.

16. A bolt retainer system installed in a triangular slip base system comprising a top slip base plate and a bottom slip base plate arranged in mirrored alignment, said bolt retainer assembly comprising:
a plurality of bolt retainer members each comprising a body, said body comprising a tail member having a distal end, and said body comprising a head member disposed opposite of said distal end;
a bolt-receiving aperture disposed through said body between said tail member and said head member; and
a tail orientation member disposed on said head member.

17. The bolt retainer system of claim 16, comprising three bolt retainer members arranged in a generally triangular configuration, with their head members disposed at the vertices of a triangular pattern and with their distal ends oriented inwardly toward a central region of the slip base assembly.

18. The bolt retainer system of claim 16, wherein the tail members are concealed between the top base plate and the bottom base plate, and wherein the head members are exposed between the top base plate and the bottom base plate.

19. The bolt retainer system of claim 16, wherein said tail orientation tab disposed on the head member of each bolt retainer member indicates orientation of said tail member when said tail member is concealed between said top base plate and said bottom base plate.

20. The bolt retainer assembly of claim 16, wherein when installed, the tail members of the bolt retainer members are disposed between the top surface of a bottom base plate and the bottom surface of a top base plate of said triangular slip base system, and the head members are exposed between the bolt-receiving notch of a top base plate and the bolt-receiving notch of a bottom base plate.
